(19) United States
(12) Patent Application Publication
(10) Pub. No.: US 2018/0181927 A1
(43) Pub. Date: Jun. 28, 2018

(54) METHOD FOR TRANSFERRING DIGITAL PAYMENT INFORMATION TO A COMPUTER SYSTEM

(71) Applicant: bezahlcode GmbH, c.o. Sellutions AG, Berlin (DE)

(72) Inventor: Tobias Stoeger, Dachau BY (DE)

(21) Appl. No.: 15/316,230

(22) PCT Filed: Jun. 2, 2015
(86) PCT No.: PCT/EP2015/062203

§ 371 Date: Dec. 5, 2016

Related U.S. Application Data
(60) Provisional application No. 62/008,172, filed on Jun. 5, 2014.

(51) Int. Cl. G06Q 20/10; G06F 17/30; G06Q 20/38; G06Q 20/32

(52) U.S. Cl. CPC G06Q 20/102; G06Q 20/108; G06F 17/30887; G06K 19/06037; G06Q 20/3276; G06Q 20/3255; G06Q 20/3829

(57) ABSTRACT

A method is provided for transferring digital payment information to a computer system. The payment information is defined with an URI, and the parameters of the URI define the recipient, the amount, the bank information, the purpose of payment. The method includes providing the URI to a computer system; reading the URI by the computer system and automatically starting an application that is assigned to the URI by an operating system of the computer system; loading the parameters of the URI by the application and providing the digital payment information in a form to the user of the computer system that allows the user to visually understand the payment information; and receiving a confirmation of the user and performing a digital payment by the application.

### FIELD OF THE INVENTION

Method for transferring digital payment information to a computer system.

### BACKGROUND OF INVENTION

Billing information can be transferred in various ways. But especially for private persons an automated way of importing payment information is not provided. The object of the invention is to provide a technical solution for the above mentioned problem.

### SUMMARY OF INVENTION

The payment code is a technical solution for (the) automatic transfer of billing information for the transfer of electronic funds. This payment information includes data, such as types of money transfer, target of transfer, amount of payment, purpose of payment, currency information, time information about payment, just to name a few. This eliminates the error-prone process of manually entering the required data in an application used for payment.

Applications for the implementation of the method can be run on mobile and stationary computers, e.g. Smartphones, laptops, desktops, to name only a few.

The payment information is imaged/generated by the billing party into a so-called PaymentCode and sent to the bill recipient, e.g. via e-mail. The recipient opens the PaymentCode with a suitable program (e.g. online banking application) and confirms the payment.

The PaymentCode is not dependent of a specific data transfer technology, but assumes that the billing software or POS system of the invoicing party generates the code and the invoice recipient has a PaymentCode-enabled online banking program (or e.g. a browser plugin for web-based online banking). Payment is made, for example, via money transfer from the individual's bank account and there is no need for third party involvement.

The payment code uses a standardized uniform resource identifier (URI) which can be used in any media, both online and offline, for example, QR codes, HTTP links, NFC tags, barcodes, iBeacons etc. Even if the QR code is referenced in the following all other media mentioned above are covered equally.

In computing, a uniform resource identifier (URI) is a string of characters used to identify a name of a web resource. Such identification enables interaction with representations of the web resource over a network (typically the World Wide Web) using specific protocols. Schemes specifying a concrete syntax and associated protocols define each URI.

These PaymentCode URIs can then be transmitted to the bill payer in a number of ways, among these are:

1. As a link in an e-mail: the bill recipient can trigger the payment process by clicking on the link in the e-mail program. The on-line banking application automatically creates a new transfer process with the data from the PaymentCode.

2. As a QR code (or barcode) on a printed bill: the bill recipient takes a photo of the code with his Smartphone (or his webcam) from a PaymentCode-enabled application. The QR code encodes a PaymentCode URI, which is then converted into a transfer process.

3. As NFC tag (or via Apple's iBeacon) at the POS: the POS terminal transmits the PaymentCode wirelessly to the Smartphone of the user, who initiates the payment via transfer in his online banking app.

The technical implementation of PaymentCode-enabled applications means that every payment that occurs by way of PaymentCode must be reported to the PaymentCode operator and the billing party, so that it can settle the transaction.

An application that supports the payment code extracts the necessary data from the URI and automatically prepares a payment. The user can then control and release the payment.

In order to guarantee the users of the payment code that the issuer of the payment code and thus the recipient is authorized, the payment code can be encrypted or can use a digital signature. In the signature the issuer of the payment code is undoubtedly deposited. The encrypted/signed payment code itself is thus protected against a change of the original payment information.

The signature is preferably a cryptographic signature. A piece of data included with a message that uses cryptographic methods to assure, at least, both message integrity and authenticity. Cryptographic signatures are used for electronically “signing” a message or a contract.

Most of current cryptographic digital signature schemes require that the recipients have a way to obtain the sender's public key with assurances of some kind that the public key and the sender identity properly belong together, and that message integrity measures (also digital signatures) assure that neither the attestation nor the value of the public key can be surreptitiously changed. A secure channel is not typically required.

A digitally signed text may also be encrypted for protection during transmission, but this is not required when most digital signature protocols have been properly carried out. Confidentiality requirements will be the guiding consideration.

Encryption of individual pay codes/certificates takes place over a PKI. When using such a PKI infrastructure the issuers of payment codes can use temporary certificates for signing and encrypting payment codes by themselves or can acquire directly signed and encrypted payment codes through the PKI (Public Key Infrastructure) provider. The signature is checked by the application running on the device receiving the payment code and the user is informed whether the payment code could be decrypted and verified and therefore whether the payment comes from a legitimate issuer. Also it has to be noted that a successful transaction will be notified by the application. The application receives a confirmation of the transaction and forwards this receipt to the user.

One aspect of the invention is a method for transferring digital payment information to a computer system, wherein the payment information is transferred with a URI, wherein the parameters of the URI define the recipient, the amount, the bank information, the purpose of the payment. The method comprises the steps of:
providing the URI to the computer system;
reading the URI by the computer system and automatically starting an application which is assigned to the URI by an operating system of the computer system. In a standard environment like Windows, Apple OS, iOS, Android®, Linux etc. it can be defined in the operating system that the specific URI is opened only with a specific application. When the operating system detects an URI the corresponding application is selected and started with the URI as a parameter;
loading the parameters of the URI by the application and providing digital payment information in a form to the user of the computer system which allows the user to visually understand the payment information. The application can provide a digital form on the display like a money transfer form, which might also be editable. The missing information like the own bank information can be provided by the application itself which stores the account information of the user in a secure databank which is encrypted;
receiving a confirmation of the user and performing a digital payment by the application. The payment can be performed by standard interfaces to the user's bank, comprising HBCI or similar.

In a possible embodiment the application is running on a mobile device with a camera, which allows reading digital barcodes. The URI can be embedded in a digital barcode, wherein the digital barcode is preferably a multidimensional code like a QR Code or other similar codes.

The URI can be send via one or more of the following: messaging system, SMS, EMAIL, collaboration platform, digital document. The URI can be send as attachment or picture or as text in the message itself.

In a possible embodiment one parameter of the URI is an electronic signature, which allows a verification of the URI and the parameter by the application. This signature can be an encrypted hash of the other parameters of the URI which can be verified by a PKI. The application connects to a PKI to verify the signature, with the use of the PKI. Counters in the URI or temporary keys can be used to avoid that the payment information is used several times. Also the application can warn the user if the same URI is used twice for payment. The application can store the URI to provide historic information.

In a possible embodiment the electronic signature is generated from a service provider and/or based on certificates owned by the issuer of the digital payment information. The issuer can transfer the payment information to the PKI provider and receives the URI with a certificate which can be forwarded to the recipient. In an alternative embodiment the PKI provides keys to the issuer which generates the signatures and the URI himself.

The PaymentCode is to be considered as a potential standard for the exchange of payment information. So that the procedure works and finds widespread distribution, the code can be supported to the greatest extent possible by the software used in the process. These are foremost:
Online banking applications (for payments by means of PaymentCode)
Invoicing software (for automatically generating invoices)
Online shop systems or
Online payment systems (such as Paypal).

It is necessary to view the connection of web-based online banking services separately, such as the online banking websites of individual banks. In these cases, the implementation of browser plugins, which are issued by the respective banks, can be considered.

Another possibility could be the implementation of a central online payment service, where customers provide authorization in a way similar to Paypal credit card data or a debit card mandate and then with payment via the PaymentCode orders are processed.

Alternative embodiments are software applications which implement the method or devices, and mobile devices which implement the method and which run the method on their processor, using the operating system, the processor, the camera and the internet interfaces to the bank.

By this approach Error-free Bill Paying in the Context of the SEPA Procedure can be provided. Generally speaking, the problem of erroneous money transfers in bill paying has proven to be a significant cost factor for companies and a nuisance for customers. Incorrectly written bank account numbers lead the invoice issuer to carry out an unnecessary process of reminders, which must then be investigated manually in each separate case. In the same way, when the purpose of payment is stated falsely this implies that a manual allocation of the incoming payment to an account or invoice will eventually be necessary. All of these procedures cost time and money—roughly estimated, an average of up to 50 € per operation. With the introduction of the SEPA process, and the associated conversion of the transfer to IBAN and BIC, it can be assumed that the number of these incidents will increase. The transferable data has become all the more complex and the manual procedure even more error-prone. PaymentCode offers the possibility to mitigate this problem and (with enhanced support) to almost eliminate it entirely.

Mobile payment is one of the topics for which a breakthrough in the future. In special combination with widely implemented banking apps the PaymentCode offers the possibility to pursue a novel approach in mobile payment systems. The difference to other procedures is that a third-party financial actor (more precisely: a special online payment service) can be eliminated. The actual transaction can be carried out exclusively via the customer's credit institution—to which already exists a relationship of trust. According to the “Mobile Payment” study by Steinbeiß Research3, by far most customers prefer the processing of mobile payment via their own bank (over 80% agreement), followed by established online payment services (Paypal, Giropay) with 45% or telephone companies (35%).

For a payment transaction, the customer scans a QR payment code at the checkout or receives the code via NFC or iBeacon and confirms the transaction in his mobile banking app.

An appropriate return channel with which the payment can be confirmed at the POS would be the transmission of a confirmation code (also via QR code or NFC) that could then be verified online from the POS terminal.

In combination with a digital signature, a unique hash value can be added to the PaymentCode. This hash can be send to a central server (e.g. bezahlcode.de) for example using web-service interface, when the payment was initiated by the payer. The payee can be informed by an automated interface, when the payment was started (e.g. by Push-Notification). As soon as the payment has been committed on the payers account, the payee can be informed again.

Also the bank can issue a confirmation and signature of the transaction details which is transmitted to the central server or directly to the payee. The payee can verify the Push-Notification due to the signature.

One of the a advantages is that

The customer doesn't need to digitize transfer vouchers on advance payments to speed up processing. The payee will also be instantly informed when the payment has been sent or booked.

### BRIEF DESCRIPTION OF DRAWINGS

FIG. 1 discloses a QR code with an URI

FIG. 2 shows a flow diagram of the invention

FIG. 3-4 show a table with parameters of the URI

### DETAILED DESCRIPTION OF PREFERRED EMBODIMENTS

In the following a method is described to transfer pre-completed remittance slips and debit notes via email to the opposite side which is able to import this information by a click. For this approach an application is assigned and registered in the Operating system to be responsible for a specific URI. Whenever this URI is clicked on the application is started.

This function in the same way for http:// or ftp:// URIs as known.

If this URI is selected in an Email, a website or a link enabled document, the Internet browser is started and opens the “payment code” website:

Analogous to the following URI the “payment code”-enabled client application is started and opens a pre-filled remittance slip:

bank://singlepayment?name=MAX+MUSTERMANN&account=12345&BNC=12345678 [symbol] &amount=5%2C99&reason=FIKTIV+SAGT+DANKE

This results in remittance slips with the following data:
Recipient: MAX MUSTERMANN
Account Number of recipient: 12345
Bank Number: 123 456 78
Amount: EUR 5,99
Reason for Payment: THANK YOU

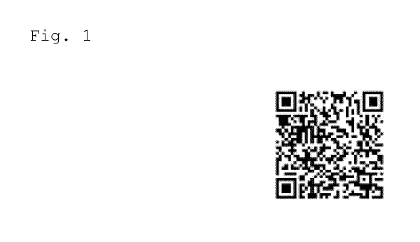

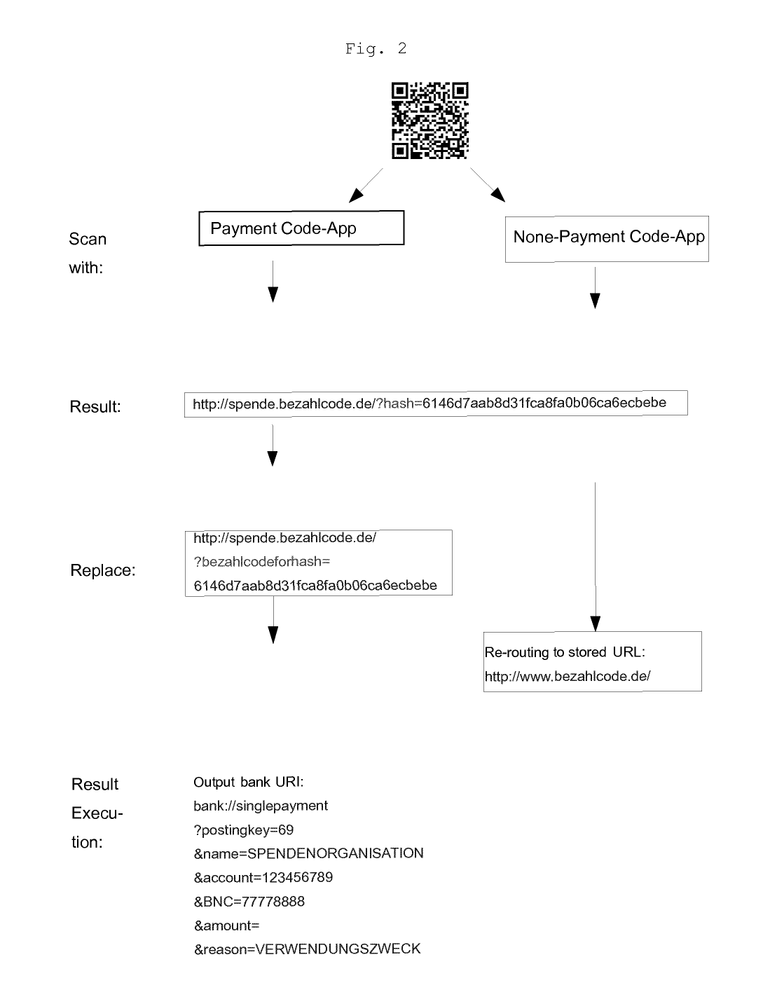

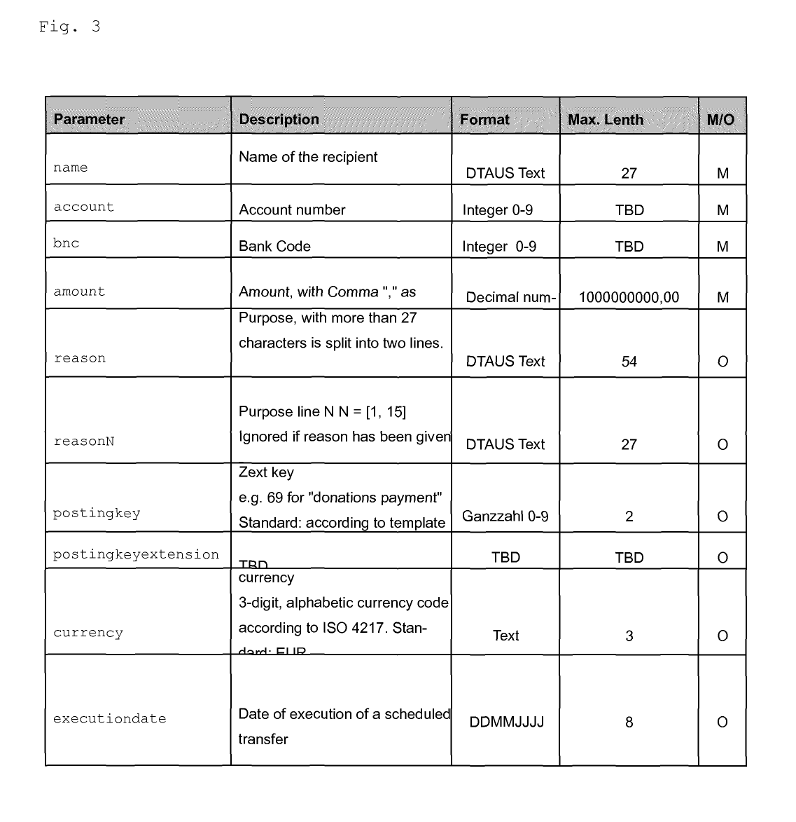

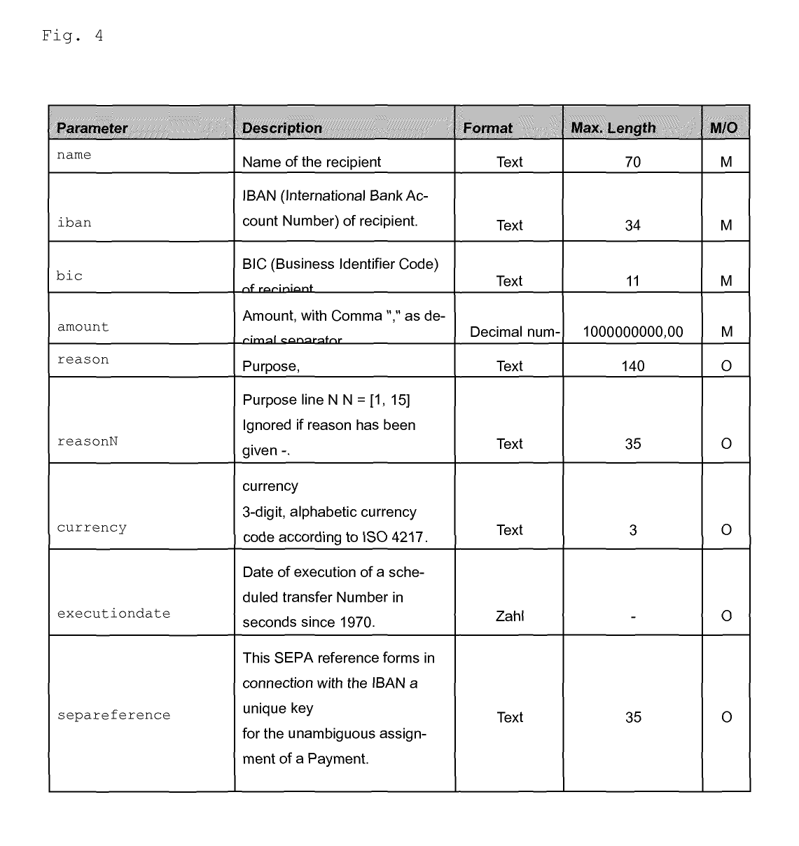

The corresponding QR code that the client application, e.g. using device camera directly from a Bill can be read, is shown in FIG. 1.

The “payment code” URI format follows the standard as described in RFC 3986 [3], the Internet Engineering Task Force is defined as followed:
URI=scheme “:” hier-part [“?” query] [“#” fragment]

Currently only scheme, hier-part (as authority) and query of the above mentioned scheme are used, the consequences are explained individually in the following.

The Authority is governed by the type of template. One Authority always has two forward slashes (/ /) ahead.

| Template Typ | Authority |
|---|---|
| Payment | singlepayment |
| SEPA-Payment | singlepaymentsepa |
| Debit | singledirectdebit |
| SEPA-Debit | singledirectdebitsepa |
| Periodic Payment | periodicsinglepayment |
| SEPA-Periodic Payment | periodicsinglepaymentsepa |
| Contact | contact |
| Contact v2 | contact_v2 |

In the query section all fields that are to be allocated are defined as a parameter.

Some of them will always be a mandatory requirement (M), while others are optional (O).
the sequence of the parameter begins with a question mark (?)
data will be assigned to a parameter with an equal sign (=)
the next parameter is connected with an introductory ampersand (&)
all non-alphanumeric characters in the data fields must be URL-encoded. Accordingly to the MIME file type application/x-www-form-urlencod or after

RFC 1738
scheme://authority?para1=data1&para2=data2&para3=data3&paraN=data

The “pay code” is based on a two-dimensional bar code, the so-called “QR code”. A “Payment code” encodes a full bank URI and can be both read from a display and from paper. Thus, this method is suitable for all kinds of invoices, remittances, debit notes. For integration into existing software, such as Online shop systems, libraries can be used.

In order to facilitate for visually impaired finding of the “payment code”, the “payment code” should be always at the same position within a document.

Based on this concept the following recommendations are made.

In order for a payment code to be detected, it should be around 2.5 cm×2.5 cm. This applies for printing (300 dpi) as well as for an on-screen display (72 dpi).

With paper invoices, it is recommended that “payment code” is located in the upper right third of the document

In this area are mostly already other billing information (number, date, Bear-workers, etc.), so that this place for the “payment code” would be obvious.

Invoices in digital format (HTML e-mail, PDF, . . . ) should be handled as well as formatting of the paper invoice.

If payment forms from the “payment code” should be right (or left) of the remittance slip in a separable field which can be separated from the remittance slip. The rest of the area may, for example, be used for a brief explanation of “payment code”.

When using the “payment code” in email or on websites or other digital media it is also recommended that the “payment code” is accommodate in the right upper third, to remain consistent with the print media. Especially with digital media it is often difficult to implement a consistent concept due to design reasons, but is should be in any case desired.

With URL-enabled formats (HTML Email, HTML, PDF, etc.) it is also recommended that behind the “payment code” image the database bank URL is clickable encoded as link tags <a> </ a>.

Looking at the document on a “payment code” an enabled device can take over the data by simply clicking, without “scanning” of the “payment code”.

To generate a “donation code”, the page http://spende.bezahlcode.de is opened.

As for the “Payment Code” the account information is collected, but in addition an URL on which redirection is performed will be used, when an application does not support payment with a “Payment code”.

The “donation code” contains no banking URI in this case, but a URL in the format:

http://spende.bezahlcode.de/?hash=6146d7aab8d31fca8fa0b06ca6ecbebe

If the “donation code” scanned into an application does not support payment code, it is redirected when calling the URL using redirection “302 Found” on the formerly stored URL.

If the donation code is scanned in a “payment code” enabled application, the URL is changed before the call “?hash=” is replaced by “bezahlcodeforhash=?”

http://spende.bezahlcode.de/?bezahlcodeforhash=6146d7aab8d31fca8fa0b06ca6ecbebe

Calling this URL does not lead to forwarding, but gives back a bank-URI, which is formatted as described above, in this case:

bank://singlepayment?postingkey=69&name=SPENDENORGANISATION&account=123456789&BNC=77778888&amount=&reason=VERWENDUNGSZWECK

1. A method for transferring digital payment information to a computer system, wherein the digital payment information is defined with an URI, wherein the parameters of the URI define the recipient, the amount, the bank information, the purpose of payment, comprising the steps:
providing the URI to a computer system by a digital information;
reading the URI by the computer system and automatically starting an online banking application that is assigned to the URI by an operating system of the computer system;
loading the parameters of the URI by the application and providing the digital payment information in a form to the user of the computer system which allows the user to visually understand the payment information;
receiving a confirmation of the user and performing a digital payment by the online banking application, wherein the application completes the payment by adding information stored in the online banking application and by connecting a banking server to execute a money transfer from the banking account that is assigned to the online banking application.

2. The method of claim 1, wherein the URI is encrypted in a digital barcode, QR Code, HTTP link, NFC tag, iBeacon.

3. The method of claim 1, wherein the URI is sent via one or more of the following:
messaging system, SMS, EMAIL, collaboration platform, digital document.

4. The method of claim 1, wherein one parameter is an electronic signature, which allows a verification of the URI and the parameter(s) by the application.

5. The method of claim 1, wherein the application connects to a PKI to verify the signature, with the use of the PKI.

6. The method of claim 5, wherein the electronic signature is generated from a service provider and/or based on certificates owned by the issues of the digital payment information.

7. (canceled)

8. The method of claim 4, wherein an in combination with a digital signature, a unique hash value is added to the URI, the hash is sent to a central server from the application when the payment is initiated by a payer, a a digital device of the payee is informed by a digital message from the central server when the payment was started.

9. The method of claim 8, wherein the digital device of the payee is informed again by a digital message, as soon as the payment has been committed on the payers account.

10. The method of claim 8, wherein the digital message is a push-notification send the payee.

11. A Computer System comprising a processing unit, network interfaces and user interfaces, to receive digital payment information from another computer system, wherein the payment information is defined with a URI, wherein the parameters of the URI define the recipient, the amount, the bank information, the purpose of payment,
the network interface is configured to receive the URI;
the processing unit is configured to read the URI and automatically start an application that is assigned to the URI by an operating system of the computer system;
to load the parameters of the URI by the application and to provide the digital payment information in a form to the user with the user interface allowing the user to visually understand the payment information;
to receive a confirmation of the user and to perform a digital payment by the online banking application over the network interface, wherein the application completes the payment by adding information stored in the online banking application and by connecting a banking server to execute a money transfer from the banking account that is assigned to the online banking application.

12. The Computer System of claim 11, wherein the URI is encrypted in a digital barcode.

13. The Computer System of claim 11, wherein the digital barcode is a QR Code, HTTP link, NFC tag, barcode, iBeacon.

14. The Computer System of claim 11, wherein the URI is sent via one or more of the following and received by the network interface:
messaging system, SMS, EMAIL, collaboration platform, digital document.

15. The Computer System of claim 11, wherein one parameter is an electronic signature, which allows a verification of the URI and the parameter by the application.

16. The Computer System of claim 15, wherein the application connects to a PKI to verify the signature, with the use of the PKI.

17. The Computer System of claim 15, wherein the electronic signature is generated from a service provider and/or based on certificates owned by the issues of the digital payment information.

18. (canceled)

19. The Computer System of claim 15, wherein an in combination with a digital signature, a unique hash value is added to the URI, the processing unit is configured to send the hash to a central server from the application when the payment is initiated by a payer, a digital device of the payee is informed by a digital message from the central server when the payment was started.

20. The Computer System of claim 19, wherein the digital device of the payee is informed again by a digital message, as soon as the payment has been committed on the payers account.

21. The Computer System of claim 19, wherein the digital message is a push-notification sent to the payee.
